(19) United States
(12) Patent Application Publication
(10) Pub. No.: US 2014/0075394 A1
(43) Pub. Date: Mar. 13, 2014

(54) METHOD AND APPARATUS TO FACILITATE INTEROPERABILITY OF APPLICATIONS IN A DEVICE

(71) Applicant: Samsung Electronics Co., Ltd., Suwon-si (KR)

(72) Inventors: Samrat Subhash NAWLE, Bangalore (IN); Neha Vijay BHARSHANKAR, Bangalore (IN); Prakash BHAGAVATHI, Bangalore (IN); Ranjith THARAYIL, Bangalore (IN)

(73) Assignee: Samsung Electronics Co., Ltd., Suwon-si (KR)

(21) Appl. No.: 14/020,208

(22) Filed: Sep. 6, 2013

(30) Foreign Application Priority Data
Sep. 7, 2012 (IN) 3719/CHE/2012

(51) Int. Cl. G06F 3/01

(52) U.S. Cl. CPC G06F 3/017
USPC 715/863

(57) ABSTRACT

A method and an apparatus to facilitate interoperability of applications in a device are provided. The method includes linking at least one application with at least one running application, storing at least one content of the linked applications in a stack, and accessing the stack using a gesture on the device.

### CROSS-REFERENCE TO RELATED APPLICATION(S)

This application claims the benefit under 35 U.S.C. §119(a) of a Indian patent application filed on Sep. 7, 2012 in the Indian Intellectual Property Office and assigned Serial No. 3719/CHE/2012, the entire disclosure of which is hereby incorporated by reference.

### TECHNICAL FIELD

The present disclosure relates to managing application interoperability on a touch screen device. More particularly, the present disclosure relates to tying multiple applications and exchanging contents across multiple applications.

### BACKGROUND

The smartphone revolution has led to the notion that the ubiquitous mobile device has been re-invented. A smartphone is a mobile device built on a mobile operating system with more advanced computing ability and connectivity than a feature phone. Many modern smartphones also include high-resolution touch screens and web browsers that display standard web pages as well as mobile-optimized sites. High-speed data access is provided by Wi-Fi and mobile broadband to quickly access the web content. In recent years, the rapid developments of mobile application markets and mobile commerce have been drivers of smartphone adoption.

Current studies reveal that smartphone users rely on their phones as a primary mean for all types of communication. Also, users continue to favor applications over the use of the browser. This creates several scenarios requiring multi-tasking, especially working between applications, content creation and so on.

Due to intrinsic multi-tasking nature of smartphones, users are more likely to use multiple mobile applications simultaneously to perform various tasks. Presently, some mobile devices only provide a frozen screen state of recent applications while swiping in between applications. From this frozen state, a user can launch applications in a fresh state. Hence, this frozen state of applications while switching is an inefficient technique to perform tasks across these applications.

In certain other smartphones, multiple applications are viewed in a single screen and these applications are scaled down to fit with the other applications. Due to the nature of scaling it is difficult to perform tasks on these applications. In current scenarios, a user cannot create group of applications by joining them together. In addition, it is difficult to perform tasks across these multiple windows due to a reduced size of an application screen.

In light of the above mentioned reasons, existing methods fail to facilitate working with the set of applications together.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and system to link multiple applications together on a single screen.

Another aspect of the present disclosure is to provide a method for a user to exchange content between linked applications.

In accordance with an aspect of the present disclosure, a method for providing interoperability among applications in a device is provided. The method includes linking at least one application with at least one running application. Further, the method stores at least one content of the linked applications in a stack. Finally, the method accesses the stack using a gesture on the device.

In accordance with an aspect of the present disclosure, a computer-readable recording medium having recorded thereon a computer program for executing the above method is provided.

In accordance with another aspect of the present disclosure, an apparatus for providing interoperability among applications in a device is provided. The apparatus includes at least one processor and at least one memory. The at least one memory stores at least one computer program. The at least one computer program includes commands to link at least one application with at least one running application, and store at least one content of the linked applications in a stack. Further the at least one computer program includes commands to access the stack using a gesture in the device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an overview of a touch screen device with multiple modules according to an embodiment of the present disclosure;

FIG. 2 illustrates a screenshot invoking a smart task manager tray with recently opened applications according to an embodiment of the present disclosure;

FIG. 3 illustrates a screenshot depicting a method of tying an application to an opened application according to an embodiment of the present disclosure;

FIG. 4 illustrates a screenshot where a multi-touch gesture is used to switch between applications according to an embodiment of the present disclosure;

FIG. 5 illustrates a screenshot depicting a copied item container in between two applications according to an embodiment of the present disclosure;

FIGS. 6A and 6B illustrate a screenshot invoking a tied application tray according to an embodiment of the present disclosure;

FIGS. 7A and 7B illustrate a screenshot of swapping and moving an application in a Tied-Applications tray according to an embodiment of the present disclosure;

FIG. 8 illustrates a screenshot showing quick-switching between tied applications according to an embodiment of the present disclosure;

FIG. 9 illustrates a screenshot to delink/un-tie a tied application according to an embodiment of the present disclosure; and

FIG. 10 illustrates a computing environment implementing a method of tying applications according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The various embodiments herein are direct toward a method and system to connect/tie/link applications to facilitate interoperability in a touch screen device. This method enables a user of the device to use and share or create content on multiple applications simultaneously. The method allows the user to use a gesture to perform any action in the touch screen device.

In the present specification, the terms ‘connect’, ‘tie’, ‘link’, and ‘join’ refer to an action of tying applications together so as to comply with the goal of the present disclosure.

In an embodiment of the present disclosure, the content can be a video, an audio, image, text, hyperlink or the like.

In an embodiment of the present disclosure, the computing device can be a mobile phone, a tablet, a Personal Digital Assistant (PDA), a personal computer, a camera, or any touch screen device.

In an embodiment of the present disclosure, the gesture includes but is not limited to a long press, a tap, a swipe, a single touch, a multi-touch, a drag, a drop, and a hover or the like.

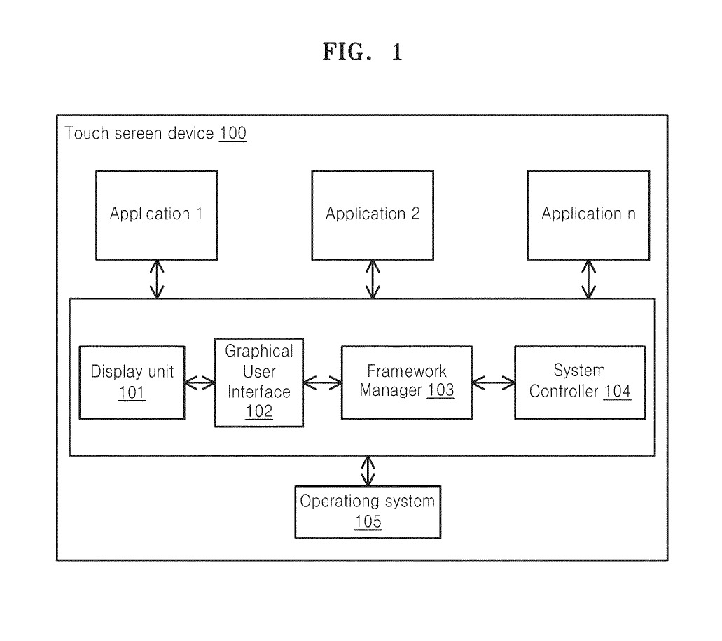

Referring to FIGS. 1 through 10, where similar reference characters denote corresponding features consistently throughout the figures, there are shown various embodiments.

FIG. 1 illustrates an overview of a touch screen device with multiple modules according to an embodiment of the present disclosure.

Referring to FIG. 1, the touch screen device 100 comprises Display unit 101, Graphical User Interface (GUI) 102, Framework manager 103, System controller 104, and Operating System (OS) 105.

The display unit 101 may be a touch sensing display unit. Particularly, the display unit 101 may be a multi-touch sensing display unit that is capable of recognizing multiple points of contact made on a surface of display unit 101. The touch screen device 100 may simultaneously display at least two application windows on display unit 101 in a multi-screen mode. Such a multi-screen mode may be initiated in response to a certain input made by a user in accordance with an embodiment of the present disclosure.

The touch screen device 100 may display an initial GUI 102 on a display area of display unit 101 when the touch screen device 100 is activated. Further, the initial GUI 102 may be produced by an operating system 105. For example, the operating system may be an android operating system, but the present disclosure is not limited thereto.

Applications may be downloaded from a related server or directly installed from an external device by a related user. The GUI 102 may enable a related user to interact with desired applications. The related user may initiate desired applications by touching icons associated with desired applications. For example, the related user may activate a music player application, as a first application, by making a touch input on the corresponding icon. In this case, the touch screen device 100 may display a first application window associated with the first application on display unit 101. The related user may activate a second application while the first application is running.

In accordance with an embodiment of the present disclosure, the touch screen device 100 may display at least two application windows simultaneously. Such a split screen mode may be initiated by invoking a smart task manager and connecting/tying a minimum of two applications together. Further, the framework manager 103 is a single interface which acts as a controller module for an entire framework. All communications are routed through the framework manager 103. Then, the system controller 104 is responsible for composing a final view to be displayed for the touch screen device 100.

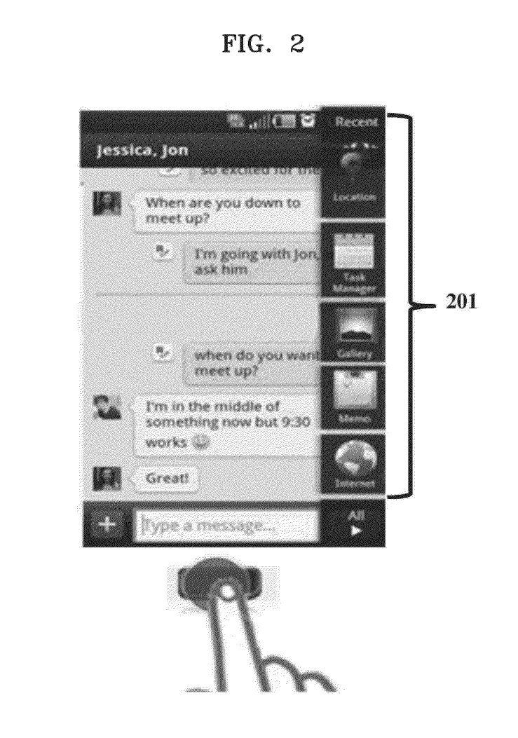

FIG. 2 illustrates a screenshot invoking a smart task manager tray with recently opened applications according to an embodiment of the present disclosure.

Referring to FIG. 2, a smart task manager tray 201 is depicted that comprises a plurality of applications on the touch screen device 100 which may be invoked by a long press gesture on a home button. The smart task manager tray 201 displays the opened (i.e., running) applications. The user can browse the remaining un-opened applications using an “All” button. The user can close the applications in the recent list by swiping the application from right to left. For example, if the user is using a texting application such as a Short Message Service (SMS) application, and wishes to link/connect/tie another application, then the user performs a long press on the home button to invoke the smart task manager tray 201 which displays opened applications and an “All” button. The smart task manager tray 201 may display recently opened applications. The user then drags and drops any opened application from this smart task manager tray 201 onto the currently displayed application (e.g., the texting application). This action “ties” the two applications. The screen displays the two applications in a split screen mode and shows a “link” icon between them. If the user wants to tie applications which are not in the smart task manager tray 201, then the user browses all the applications in the touch screen device 100 using an “All” button.

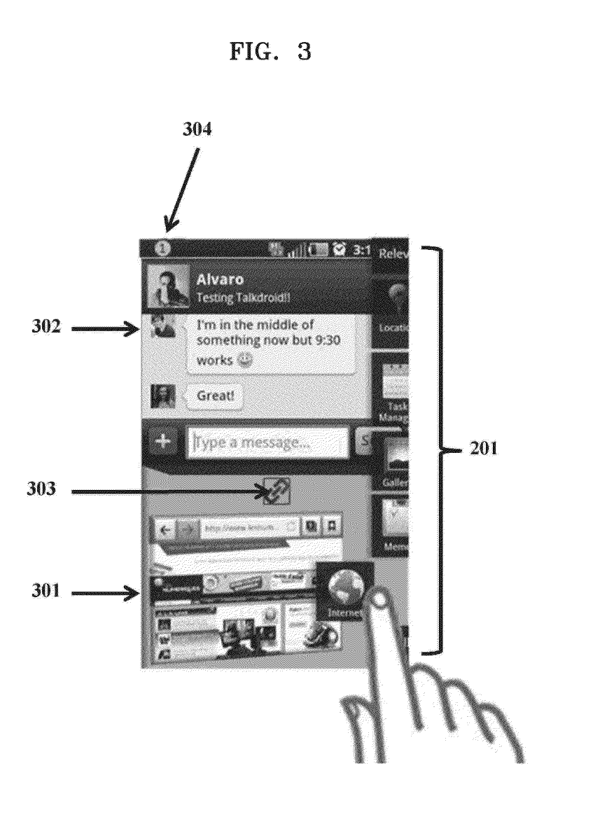

FIG. 3 illustrates a screenshot depicting a method of tying an application to an opened application according to an embodiment of the present disclosure.

Referring to FIG. 3, a process is shown of tying an application with the already opened application. FIG. 3 shows the smart task manager tray 201 of opened applications. The user wishes to tie browser application 301 in the smart task manager tray 201 to texting application 302 in the screen. The user then drags the browser application 301 and drops it onto the screen. Then between two applications, a tie icon 303 is displayed to depict the joining between the two applications. Also, the status bar of the device displays an icon 304 showing the number of tied applications. The number of applications tied to the opened application in FIG. 3 is one, which is notified by the icon 304.

In an embodiment of the present disclosure, using a single touch interaction the user may interact individually with all tied applications.

In another embodiment of the present disclosure, using a multi-touch interaction the pan action is activated and this allows the user to scroll all tied applications in an up-down direction. Multi-touch is a method of input on the touch screen device 100 that allows two or more fingers to be used on the screen at one time. Multi-touch gestures allow pinching and stretching gestures on the screen to control zooming. On multi-touch of the touch screen device 100 in the present disclosure, the pan action is activated and allows the user to scroll all the tied up applications in an up-down direction. The user can also view any two adjoining applications in the split screen mode.

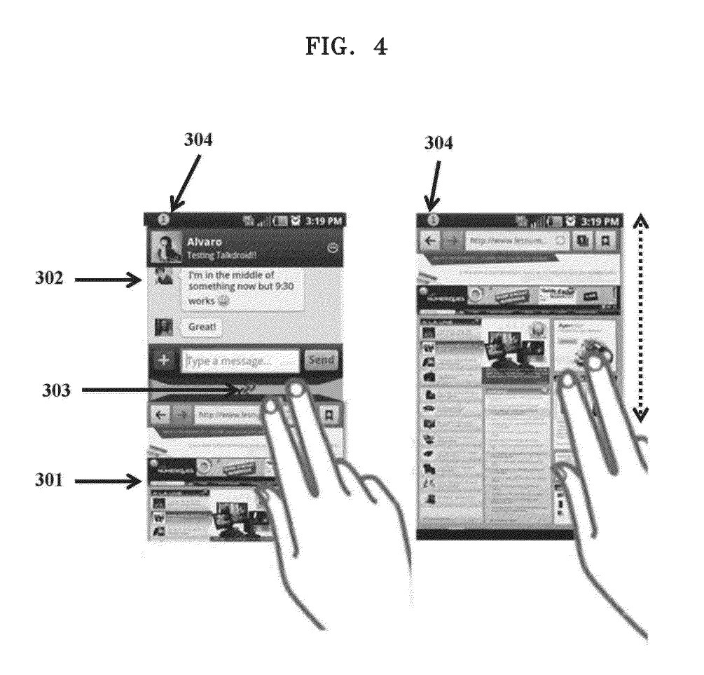

FIG. 4 illustrates a screenshot where a user performs a multi-touch gesture to switch between applications according to an embodiment of the present disclosure.

Referring to FIG. 4, the browser application 301 is tied to the texting application 302. The tie icon 303 is shown between the two applications and the number of applications tied is shown in the icon 304 on the notification bar of the touch screen device 100. As depicted in FIG. 4, the user performs swipe up or down using a multi-touch gesture, to scroll/navigate between tied-applications. For example, the user performs any multi-touch gesture to switch between applications. While scrolling, if the area/region where the two applications are tied (depicted with a tie icon 303) is in a central or close to central portion of the display, then the tied-applications stop scrolling and snap to the position such that the tied region rests in the central portion of the display screen, with the two applications displayed half-half In portrait orientation of touch screen device 100 the applications can be one up, one down, and while the touch screen device 100 is in landscape orientation, the applications could be displayed side by side. The user may work on both applications simultaneously. This may be useful if the touch screen device 100 has a larger display, e.g., a Phablet, a tablet, or the like. If during scrolling, the tied area reaches or comes closer to either the top or bottom (in the case of landscape orientation far left/right) of the display then the application with a maximum area is displayed. In the split screen mode, both applications are seen in half (with respect to size of the screen of the touch screen device 100) along with the tied icon 303 in between the two applications. For example, consider that a touch screen device 100 user may have opened a gaming application and is also using the contact application such as the “whatsapp” application. The screen of the touch screen device 100 will be divided into 2 screens (e.g., split-screen mode) to display both the gaming application and the “whatsapp” application. When the user wishes to use only the “whatsapp” application, then user may perform a multi-touch gesture on the application to switch the application into the full screen mode.

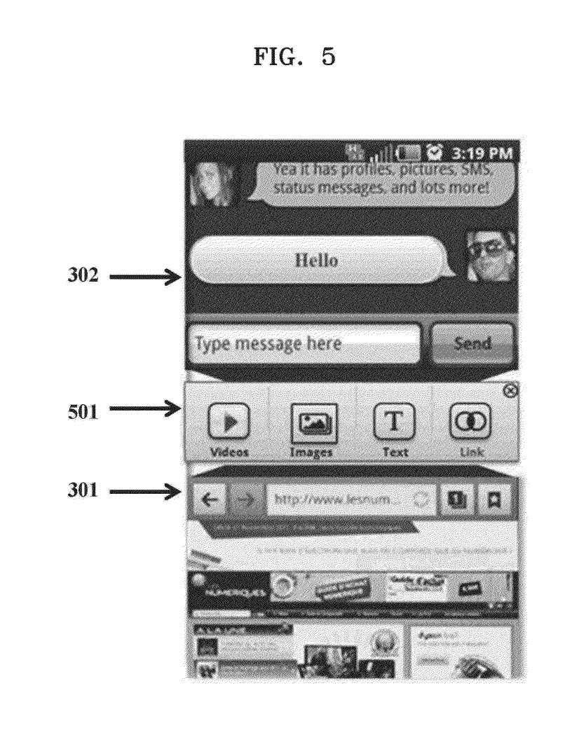

FIG. 5 illustrates a screenshot depicting a copied item container in between two applications according to an embodiment of the present disclosure.

Referring to FIG. 5, the browser applications 301 and the texting application 302 are shown. FIG. 5 depicts the copied item container 501 in which all the copied content and data from each of the tied applications are stacked according to the item types in specific folders such as video, image, text, Uniform Resource Locator's (URLs) and so on.

In an embodiment of the present disclosure, the copied item container 501 can be invoked by long-pressing in the tied area between any two adjoining linked applications (where the link icon is seen). It appears in this area in between the two tied applications. The copied item container 501 allows users to share, edit or copy content/data across tied applications.

In an embodiment of the present disclosure, the copied item container 501 has a special clipboard functionality which allows more than one copied item to remain within each content type folder, until deleted by the user.

For example, when the user is creating a report and has to refer to multiple documents and websites. With this method, the user can tie applications such as a document reader and a browser and copy content across documents and websites at the user's pace without a need to go between those applications. The content is saved in the respective item folders of the copied item container 501. The user can access all copied content at a later stage by invoking the copied item container 501 as described above.

In an embodiment of the present disclosure, the copied item container 501 can be available as a widget which can be displayed in a home screen or the like.

In an embodiment of the present disclosure, the content present in the linked applications is shown to the user to view ‘content output’ and ‘content input’ using the interfaces provided by each application. For example, if the linked application is the browser, then the content input can be a URL, keywords or the like.

In an embodiment of the present disclosure, when two (or more) applications have been ‘linked’, then the types of content that can be exchanged between these applications is shown in a tangible visual form, such as thumbnails that include but are not limited to an image, metadata description or the like.

For example, the tangible visual form is shown alongside the linked applications which allow the user to decide the type of content to be exchanged between the linked applications and also provides an indication depicting the result of the content transfer from one application to the other application.

In an embodiment of the present disclosure, the touch screen device 100 displays contents based on the information from a previous connection between such applications. For example, if the user already selected the type of connection between applications, then such content has a higher weight and is shown in higher order.

In another embodiment of the present disclosure, if a certain type of content information is published as ‘preferred’ or ‘more acceptable’ or ‘required input’ by applications through their interfaces (for example, in their manifest file in the Android platform) then their order is shown in a higher order.

In another embodiment of the present disclosure, the touch screen device 100 determines a direct match between a particular input and output information, if an ongoing task of the user will be accomplished. Then, such content is shown in higher order. For example, if the user was in the process of attaching an artifact (e.g., a document, an image or the like) and linked an application that has a recent artifact open, then linking these two applications will bring the recent artifact to view at a higher order.

In an embodiment of the present disclosure, once the content is chosen by the user to transfer between linked applications, the application will ‘resume’ from its previous state (when smart task manager was started). In an embodiment, at this point the application may display a sequence of User Interface (UI) operations automatically showing how the content transferred from the other application affected the state of the current application. For example, when the user selects the URL in the browser application, then the browser application may resume and open the selected URL in a new tab.

In an embodiment of the present disclosure, an undo option is provided to the user to negate content transfer. The user may avail this option by performing the gesture in the smart task manager of the touch screen device 100.

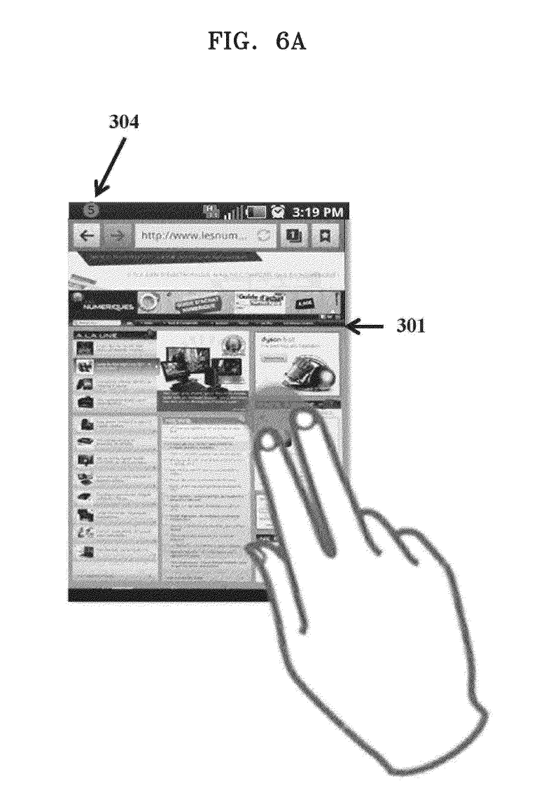

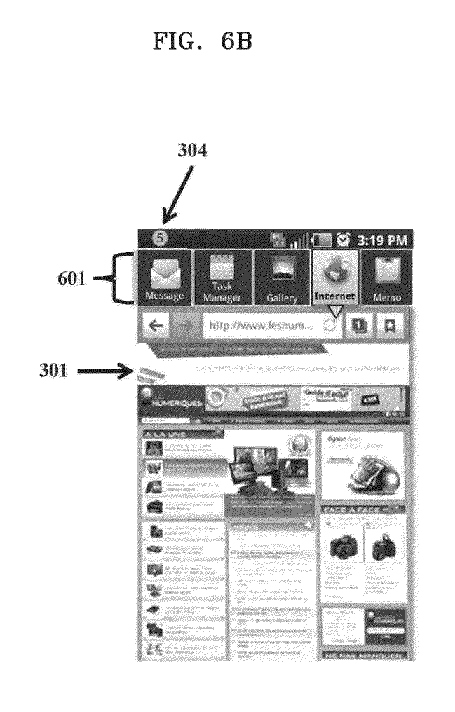

FIGS. 6A and 6B illustrate a screenshot invoking a tied-application tray according to an embodiment of the present disclosure.

Referring to FIGS. 6A and 6B, the browser application 301 and an icon 304 including the number of applications tied is shown in the notification bar of the touch screen device 100. As depicted in the FIG. 6A, the user performs a multi-touch long press gesture on any displayed tied-application either in a full screen or split screen mode. Upon receiving the multi-touch gesture, a tied-applications tray 601 containing all tied applications is launched as shown in FIG. 6B. FIGS. 6A and 6B show an application icon (e.g., internet which represents the browser application) in a selected mode for an active application (e.g., browser). For example, the tied-applications tray 601 includes a messaging application, a task manager, a gallery, a browser application and a Memo, which the user tied using the tie icon 303.

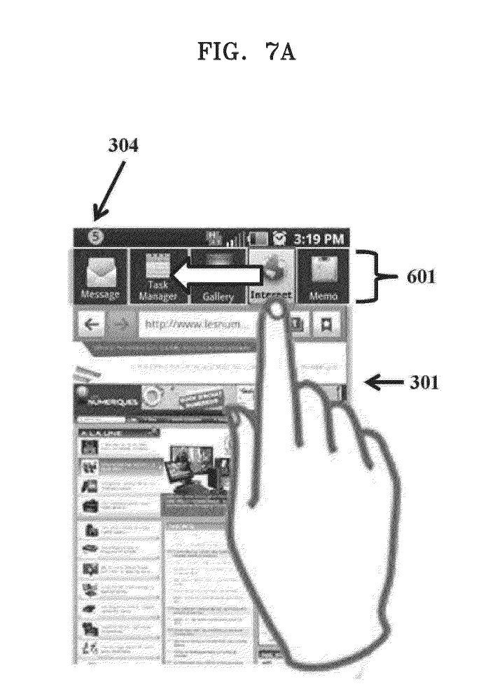

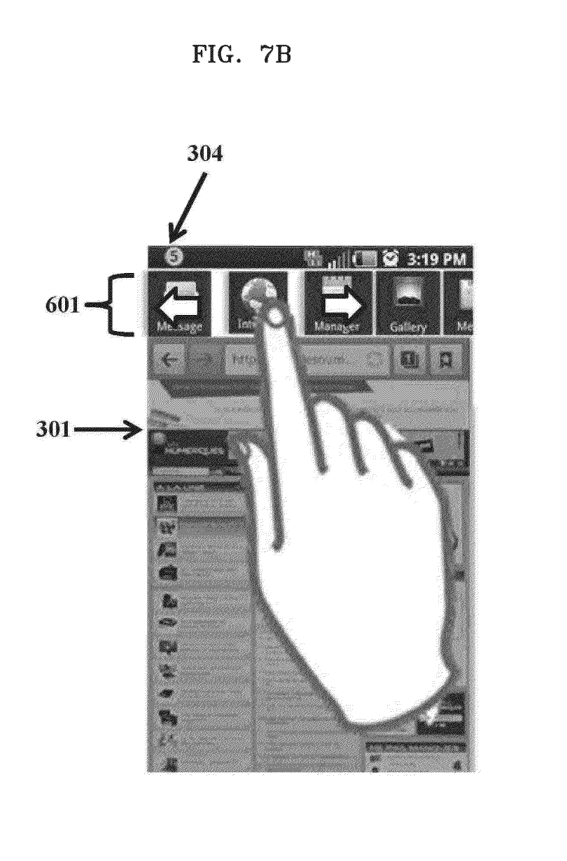

FIGS. 7A and 7B illustrate a screenshot of swapping and moving an application in the Tied-Applications tray according to an embodiment of the present disclosure.

Referring to FIGS. 7A and 7B, the browser application 301 and an icon 304 including the number of tied applications are shown in the notification bar of the touch screen device 100. As shown in the FIG. 7A, the user swaps or re-orders any application by selecting that application icon in the tied-applications tray 601 through a single-touch long press gesture and dragging it to a new or different position in the tied-applications tray 601. The application icons nearby where the application icon is being repositioned move aside to accommodate the swapped or re-ordered application (in the direction of the arrows as depicted in FIG. 7B). As shown in the FIG. 7B, the user swaps any other application within the tied-applications tray 601 by performing a drag and drop of the selected application to move the selected application to a new position.

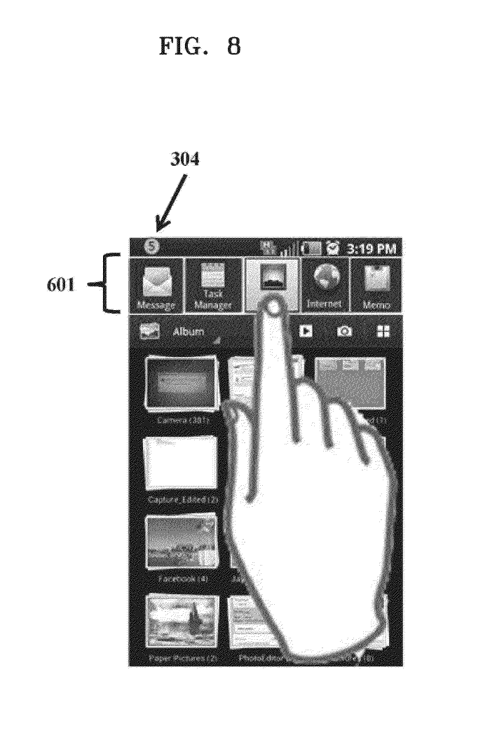

FIG. 8 illustrates a screenshot showing quick-switching between tied applications according to an embodiment of the present disclosure.

Referring to FIG. 8, the tied-applications tray 601 (with application icons of all tied-applications) is launched. An icon 304 including the number of tied applications is shown in the notification bar of the touch screen device 100. For quick-switching to any tied-application the user scrolls through the list of tied-application icons in the tied-applications tray 601 and taps on an application icon of an application that needs to be switched.

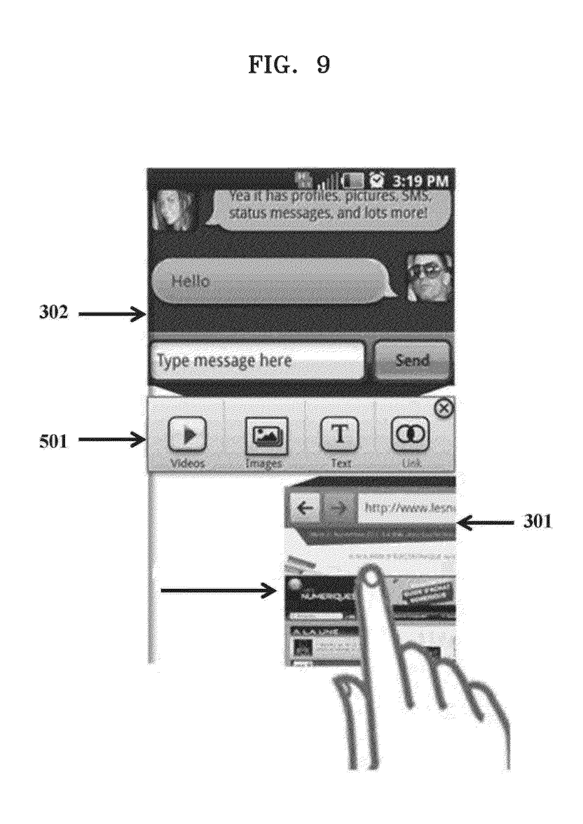

FIG. 9 illustrates a screenshot to delink/un-tie a tied application according to an embodiment of the present disclosure.

Referring to FIG. 9, the browser application 301, the texting application 302, and the copied item container 501 are shown. In order to delink the application displayed on the screen of the touch screen device 100, the user swipes the tied application to the right when the device is in the split screen mode. In an embodiment, the user may perform any gesture to delink the tied applications. As soon as the application is delinked/untied, the below/above tied application is pushed up/down and gets tied with the upper/lower application. The reduced number of tied applications is notified using the icon 304 in the notification bar of the touch screen device 100.

For example, consider a user using the video player application (upper application) and music player application (lower application) in the split screen mode. Once the user closes the video player application by swiping to the right of the said application in the split screen mode, the below tied application that is the music player application is pushed up and it is tied as the upper application.

In the context of the present disclosure, various embodiments disclosed herein are generally directed towards an efficient and reliable technique to connect applications to facilitate inter-operability. A plurality of applications may be tied to one another depending upon the user's preferences to create a set of applications.

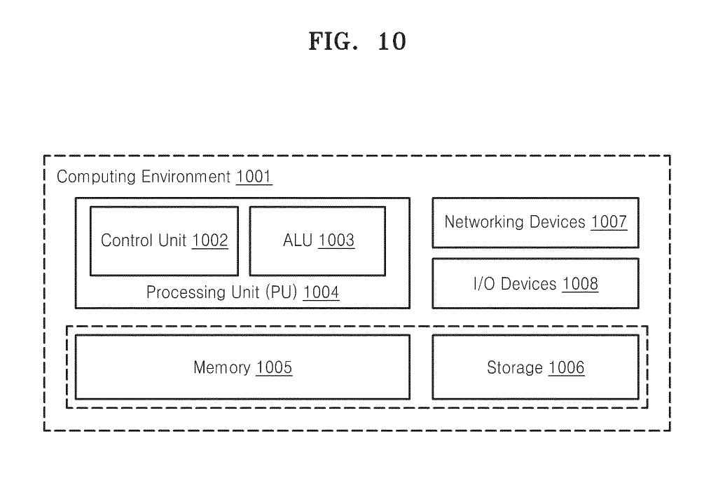

FIG. 10 illustrates a computing environment implementing a method of tying applications according to an embodiment of the present disclosure.

Referring to FIG. 10, a computing environment 1001 comprises at least one processing unit 1004 that is equipped with a control unit 1002 and an Arithmetic Logic Unit (ALU) 1003, a memory 1005, a storage 1006, plurality of networking devices 1007 and a plurality Input/Output (I/O) devices 1008. The processing unit 1004 is responsible for processing the instructions of the algorithm. The processing unit 1004 receives commands from the control unit in order to perform its processing. Further, any logical and arithmetic operations involved in the execution of the instructions are computed with the help of the ALU 1003.

The overall computing environment 1001 can be composed of multiple homogeneous and/or heterogeneous cores, multiple Central Processing Units (CPUs) of different kinds, special media and other accelerators. The processing unit 1004 is responsible for processing the instructions of the algorithm. Further, the plurality of processing units 1004 may be located on a single chip or collectively over multiple chips.

The algorithm comprising of instructions and codes required for the implementation are stored in either the memory unit 1005 or the storage 1006 or both. At the time of execution, the instructions may be fetched from the corresponding memory 1005 and/or storage 1006, and executed by the processing unit 1004.

In case of any hardware implementations various networking devices 1008 or external I/O devices 1005 may be connected to the computing environment to support the implementation through the networking devices 1008 and the I/O devices 1005.

The embodiments disclosed herein can be implemented through at least one software program running on at least one hardware device and performing network management functions to control the elements. The elements shown in FIGS. 1 and 10 include blocks which can be at least one of a hardware device, or a combination of hardware device and software module.

While the present disclosure has been shown and described with reference to various embodiments thereof, it will be understood by those skilled in the art that various changes in form and details nay be made therein without departing from the spirit and scope of the present disclosure as defined by the appended claims and their equivalents.

What is claimed is:

1. A method for providing interoperability among applications in a device, the method comprises:
linking at least one application with at least one running application;
storing at least one content of the linked applications in a stack; and
accessing the stack using a gesture on the device.

2. The method as in claim 1, further comprising:
displaying the at least one application in at least one of a split screen mode and a full screen mode in the device when the gesture is performed.

3. The method as in claim 1, further comprising:
de-linking the at least one application with the at least one running application when another gesture is performed.

4. The method as in claim 3, wherein the gesture comprises at least one of a long press, a tap, a swipe, a single touch, a multi-touch, a drag, a drop, and a hover in the device.

5. The method as in claim 1, further comprising:
exchanging the at least one content between the linked applications.

6. The method as in claim 1, further comprising:
displaying a type of the at least one content exchanged among the at least one application and the running application in a visual form.

7. The method as in claim 5, further comprising:
displaying the exchanged at least one content in an order based on information,
wherein the information comprises at least one of a previous connection between the at least one application and the running application, a type of the at least one content, and a direct match between the at least one application and the running application.

8. The method as in claim 5, further comprising:
resuming the at least one application when the at least one content is exchanged between the at least one application and the running application.

9. A non-transitory computer-readable recording medium having recorded thereon a computer program for executing the method as in claim 1.

10. An apparatus for providing interoperability among applications in a device, the apparatus comprises:
at least one memory; and
at least one processor configured to execute at least one computer program stored in the at least one memory,
wherein the at least one computer program comprises commands to:
link at least one application with at least one running application;
store at least one content of the linked applications in a stack; and
access the stack using a gesture in the device.

11. The apparatus as in claim 10, wherein the at least one computer program further comprises commands to display the at least one application in at least one of a split screen mode and a full screen mode in the device when the gesture is performed.

12. The apparatus as in claim 10, wherein the at least one computer program further comprises commands to de-link the at least one application with the at least one running application when another gesture is performed.

13. The apparatus as in claim 12, wherein the gesture comprises at least one of a long press, a tap, a swipe, a single a touch, a multi-touch, a drag, a drop, and a hover in the device.

14. The apparatus as in claim 10, wherein the at least one computer program further comprises commands to exchange the at least one content between the linked applications.

15. The apparatus as in claim 10, wherein the at least one computer program further comprises commands to display a type of the at least one content exchanged among the at least one application and the running application in a visual form.

16. The apparatus as in claim 14, wherein the at least one computer program further comprises commands to display the exchanged at least one content in an order based on information, and
wherein the information comprises at least one of a previous connection between the at least one application and the running application, a type of the at least one content, and a direct match between the at least one application and the running application.

17. The apparatus as in claim 14, wherein the at least one computer program further comprises commands to resume the at least one application when the at least one content is exchanged between the at least one application and the running application.
